(19) United States
(12) Patent Application Publication
(10) Pub. No.: US 2003/0039804 A1
(43) Pub. Date: Feb. 27, 2003

(54) Article for cleansing, treating, and/or exfoliating skin

(76) Inventors: David A. Burwell, Princeton, NJ (US); Lynn Aridgides, Franklin Park, NJ (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 09/938,683

(22) Filed: Aug. 24, 2001

(51) Int. Cl. B32B 3/10

(52) U.S. Cl. 428/138; 428/141

(57) ABSTRACT

A bilayer laminated personal care article including an apertured film layer having a smooth side and a rough side; and an absorbent layer, wherein the absorbent layer is laminated to the smooth side of the apertured film layer, and the article is useful for providing skin care benefits is disclosed.

### BACKGROUND OF THE INVENTION

1. Field of the Invention

The present invention relates to an article that is useful for cleansing and/or exfoliating the skin. The article has a smooth surface and a rough surface. The smooth surface may be a woven or knit fabric, a nonwoven, or a flocked fabric. The rough surface may be a polymeric film having apertures. The smooth surface is useful for mild cleansing or cleansing of delicate areas, such as the face. The rough surface is useful for deep cleansing and/or exfoliating the skin. The article may contain an active that is intended to be applied to, or interact with, the surface of the skin. In one embodiment, the article has a drapability of from about 25 mm to about 100 mm.

2. Description of t1he Prior Art

In recent years, many articles have been developed to aid in wiping various substrates. One example is the development of baby wipes, which are used to wipe the baby clean during diaper changes. Baby wipes typically are soft and are loaded with a cleanser and moisturizer. Baby wipes are not known for exfoliating properties. As used herein, exfoliating means removing dead skin from the surface of the skin.

Another type of wipe that has been developed is the hand wipe. Hand wipes are used to clean the hands when the use of a sink is inconvenient. These wipes typically are not as soft as baby wipes. Hand wipes frequently contain both cleansers and antibacterial agents. Hand wipes are not known to have exfoliating properties.

Wipes have also been developed for cleaning the face. These wipes are typically very soft and contain cleansers, moisturizers, and other skin active ingredients. Most face wipes are not known for exfoliating properties. The BUFF-PUFF® pad is sold commercially by 3 M Company for exfoliating and cleansing the face. The pad is made from a spun-bond polymer and has a very rough texture. Although the pad is effective at cleansing and exfoliating the skin, some consumers find the pad to be too rough. Therefore, there is a need for a wipe that cleans and exfoliates the skin without being too rough on the skin.

U.S. Pat. No. 6,132,841 teaches a wiping device having an apertured film and an absorbent core. The absorbent core may be a nonwoven and the like, and is loaded with a liquid, such as a cleanser. The liquid is held in the absorbent layer by capillary action. When the consumer wants to use the wipe, he or she squeezes the wipe to express the liquid from the absorbent core, then cleanses by wiping. The patent does not teach a wipe having a soft surface for mild cleansing and cleansing delicate areas. It also does not teach the importance of drapability with respect to the softness of the wipe.

Despite the disclosure of the prior art, there remains a need for a wipe that is soft and flexible, and cleans and/or exfoliates the skin.

### SUMMARY OF THE INVENTION

The present invention provides a bilayer laminated personal care article including an apertured film layer having a smooth side and a rough side; and an absorbent layer, wherein the absorbent layer is laminated to the smooth side of the apertured film layer, and the article is useful for providing skin care benefits.

### BRIEF DESCRIPTION OF THE DRAWINGS

FIG. 1 is a 22× micrograph of the article of the invention of Example 10.

### DETAILED DESCRIPTION OF PREFERRED EMBODIMENTS

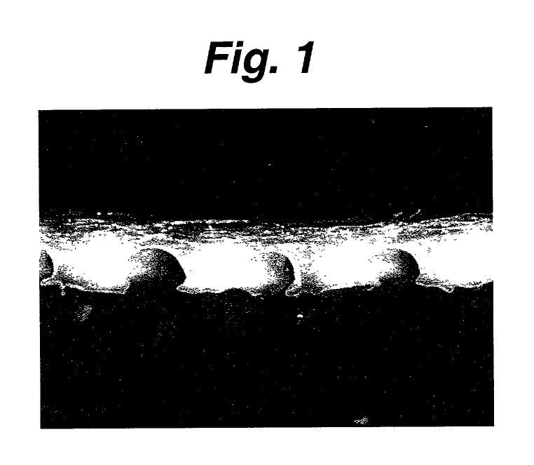

The article of the present invention has two layers. One layer of the article is an apertured film. Apertured films are textured films, which contain raised protuberances that may be made by a number of methods. Generally speaking, apertured films possess a “rough” side, which contains the raised protuberances as shown in the micrograph of the apertured film in FIG. 1, and an opposing “smooth” side as shown in the same micrograph of the apertured film. The smooth side of the apertured film of FIG. 1 has a nonwoven laminated to it. By “smooth” side, it is meant the side from which the raised protuberances originate. The protuberances in such apertured films are generally cone-shaped. These films may be made from any polymeric material including, but not limited to polyolefins, such as, but not limited to, polyethylene, metallocene catalyzed polyethylene, polypropylene, and copolymers thereof, blends of various molecular weight polymers, and ethylene vinyl acetate copolymers. Such apertured films are disclosed in U.S. Pat. Nos. 3,054,148, 4,324,246, 4,342,314, 4,351,784, 4,463,045, 4,535,020, and 5,006,394, each of which is hereby incorporated by reference.

The thickness of the apertured film prior to forming apertures may range from about 0.015 mm to about 0.038 mm, for example from about 0.018 mm to about 0.030 mm, or from about 0.020 mm to about 0.025 mm.

The apertures may be created in the films via known processes, see, e.g., U.S. Pat. Nos. 4,741,877; 3,929,135 and 3,394,211; 3,929,135; 3,394,211; 4,629,643 and 4,839,216 and European Patent Application No. 1,040,803, each of which is hereby incorporated by reference.

The size of the apertures and the number of apertures per square centimeter may vary, depending on the properties desired, for example foaming and softness. Generally, the apertured film comprises multiple apertures in an amount ranging from about 1 apertures/cm² to about 300 apertures/cm², for example, from about 3 apertures/ cm² to about 150 apertures/cm², or from about 10 apertures/cm² to about 100 apertures/cm². In one embodiment, the apertures have a depth of greater than 0 mm to about 3 mm. The size of the apertures, measured as the average diameter of the apertures across the smooth side of the textured film, ranges in size from about 0.01 cm to about 0.6 cm, for example from about 0.02 cm to about 0.4 cm, or from about 0.3 cm to about 0.2 cm.

Examples of suitable commercial apertured films include those available from Tredegar Corporation, Inc. under the tradename, VISPORE®, from Polymer Group, Inc. under the tradename, RETICULON®, or from Guial Inc. under the tradename, ZEOLE with the VISPORE® film being preferred. Further examples of apertured films suitable for use in the present invention include VISPORE® 6178, VISPORE®6170, Apertured PENTAFLEX L 1.0 ml film, Apertured 14 SQUARE 1.0 ml film, Apertured PENTAGONAL 1.0 ml film, Apertured PENTAFLEX L 0.8 ml film, Apertured PENTAGONAL 0.8 ml film, Apertured 25 PENTAGONAL Soft Blend 0.8 ml film, and Apertured 19 mesh PENTAFLEX L Soft Blend 0.8 ml film having a resilience of 98.0 and a compression of 35.2 wherein the density of the apertures is about 55 per cm², the diameter about 579 microns in the machine direction and 616 microns in the cross machine direction, each available from Tredegar Corporation, Inc.

The textured film utilized in the present invention may have materials, such as film modifiers, added to it to improve the performance of the article. The film modifier may be impregnated into and/or deposited onto the textured film. Any film modifier known in the art to enhance the physical and/or aesthetic properties of the film may be added. Examples of suitable film modifiers include surfactants, anti-microbial agents, anti-bacterial agents, colorants, fragrances, fillers, silica, pumice, mica, and mixtures thereof. An example of a suitable anti-bacterial agent is Microban™.

A surfactant may be added to the film in an amount effective to improve wetting. Any surfactant including, but not limited to, nonionics, anionics, cationics, amphoterics, betaines, and combinations thereof may be utilized. The surfactants may be incorporated into the substrate during the process of making the film (ie., be included in the polymerization process for making polymers that are used to make apertured films). Alternatively, the surfactant may be impregnated, deposited, and/or coated onto or into the apertured film by means known in the art.

An absorbent layer is laminated to the apertured film layer. The absorbent layer may be a woven or knit fabric, a nonwoven, or a flocked fabric. Methods of making woven and knit cloths are not a part of this invention and, being well known in the art, are not described in detail herein.

One type of nonwoven utilized as the absorbent layer in the present invention is made by air- or water-laying processes in which the fibers or filaments are first cut to desired lengths from long strands, passed into a water or air stream, and then deposited onto a screen through which the fiber-laden air or water is passed. The deposited fibers or filaments are then bonded together, and otherwise treated as desired to form the woven, nonwoven, or cellulose cloth.

The absorbent layer utilized in the present invention may also be a thermal bonded nonwoven cloth (whether or not resin-containing) which can be made of polyesters, polyamides, polyolefins, or other thermoplastic fibers which can be spun bonded, i.e., the fibers are spun out onto a flat surface and bonded (melted) together by heat or chemical reactions, or carded and bonded.

When nonwoven substrates are utilized in the present invention, the nonwovens are generally adhesively or thermally bonded fibers or filamentous products having a web or carded fiber structure (when the fiber strength is suitable to allow carding) or comprising fibrous mats in which the fibers or filaments are distributed haphazardly or in random array (i.e., an array of fibers in a carded web where partial orientation of the fibers is frequently present, as well as a completely haphazard distributional orientation), or substantially aligned. The fibers or filaments can be natural (e.g., wool, silk, jute, hemp, cotton, linen, sisal, or ramie) or synthetic (e.g., rayon, cellulose ester, polyvinyl derivatives, polyolefins, such as polyethylene and polypropylene, polyamides, such as nylon 6, nylon 6,6, or polyesters, such as polyethylene terephthalate and polybutylene terephthalate), or combinations thereof. These nonwoven materials and their methods of manufacture are generally described in the INDA “NONWOVEN FABRICS HANDBOOK”, (1999), hereby incorporated by reference. Suitable nonwovens are commercially available, for example through PGI Nonwovens, BBA Corporation, Freudenberg Corporation, and DuPont Corporation. Examples of such nonwovens include, but are not limited to PGI 6757, PGI 67DCO, and PGI 6705.

The basis weight of the absorbent layer may vary, but generally ranges from about 10 grams per square meter to about 200 grams per square meter, for example from about 15 grams per square meter to about 100 grams per square meter, or from about 20 grams per square meter to about 50 grams per square meter.

The absorbent layer is laminated to the apertured film layer by means known in the art. Suitable means include, but are not limited to, thermal bonding, adhesive bonding, sewing, ultrasonic welding, and the like. One such laminating means is disclosed in U.S. Pat. No. 5,635,275, which is hereby incorporated by reference. The absorbent layer is laminated to the smooth surface of the apertured film layer. This provides an article that has a smooth surface (the absorbent layer) for mild cleansing and cleansing delicate areas, and a rough surface (the protuberances of the apertured film) for deep cleansing and/or exfoliating the skin.

The articles of the present invention provide a skin care benefit or a hair care benefit. As used herein, skin care benefit and hair care benefit means massaging, cleansing, scrubbing, treating, and/or exfoliating the skin or hair.

The articles of the invention are preferably combined with cleansers, skin care actives, moisturizers, and the like. The articles may be loaded with appropriate skin care compositions and packaged as wet wipes. The skin care compositions may be loaded onto the wipes by dipping the wipes in the skin care composition, spraying the skin care composition onto the wipes, and other means known in the art.

Alternatively, the wet wipe may be dried through the use of heating equipment, vacuum driers, or other means known in the art to provide dry wipes. Alternatively, a cleansing or skin care formulation may be applied in the form of a concentrate to the substrate to provide dry articles. The dry articles or wipes are sold dry, then the consumer wets the wipe with water when ready for use. Examples of suitable methods for manufacturing dry articles useful in the present invention are disclosed, for example, by U.S. Pat. No. 6,063,397, which is hereby incorporated by reference.

The articles of the invention are utilized in personal care applications therefore the articles should be soft and flexible. Several tests are performed to demonstrate that the articles are soft and flexible. Those tests include Drape, Compressibility, Bond Strength, and Resiliency.

The Drape test provides an indication of the flexibility of the article. The article (12.7 cm×12.7 cm) is placed on a platform, 2.54 cm above a table. The sample is aligned on the platform such that the Drape of the sample is measured in the machine direction. One end of the article is moved over the edge of the platform in small increments. The test is completed when the end of the article touches the surface of the table. Drape is reported as the minimum length of the article extending over the edge of the platform (in mm) required for the article to touch the surface of the table. Stiff articles will have much higher Drape scores than flexible articles. For the article to be suitable for personal care applications, the Drape score preferably ranges from about 25 mm to about 100 mm, for example from about 25 mm to about 75 mm, or from about 25 mm to about 40 mm.

Compressibility is an indicator of the softness of the article. The article (10 cm×10 cm) is measured for height in mm. Weight (862.6 g) is applied to the article and the article is compressed for 10 seconds. The height of the compressed article is measured. The compressed height is subtracted from the original height. Compressibility is reported as the difference in heights in terms of percent of original height. For personal care applications, the Compressibility preferably is greater than about 14 percent, for example greater than about 18 percent, or greater than 25 percent.

Resiliency is an indication of the softness of the article of the invention. The article is compressed as described above in the compressibility test. The weight is removed and the article recovers for 10 seconds. The height of the article is measured prior to compression and after recovery. Resiliency is reported as the recovery height in terms of percent of the original height. For personal care applications, the Resiliency preferably is greater than about 85 percent, for example, greater than about 90 percent, greater than about 92 percent, or greater than 94 percent.

The apertured film layer and the absorbent layer are laminated. One method of lamination includes applying an absorbent material to a molten film and cooling the laminate. This results in a bond between the absorbent layer and the apertured film layer. The bond strength between the layers is important. If the bond is too weak, the layers will tend to delaminate. If the bond strength is too strong, the article will tend to be too stiff for personal care applications.

Bond strength is measured by using an Instron (Model 1130 with Microcon II) force measuring instrument. Double sided tape with release paper (#231 from Duo-Fast Corporation) is applied to each side of each sample. A tab of tape that measures 5 cm extends from each side at one end of each sample. A 2.54 cm×25.4 cm strip is cut from the tape covered sample. The tabs are attached to the jaws of the Instron and the taped surfaces are pulled apart at 30.5 cm per minute by the Instron. The force required to separate the layers is measured and reported in g/cm². For personal care applications, the bond strength preferably ranges from about 70 g/cm² to about 350 g/cm², for example from about 100 g/cm² to about 300 g/cm², or from about 150 g/cm² to about 300 g/cm².

The advantages of the invention and specific embodiments of the articles prepared in accordance with the present invention are illustrated by the following examples. It will be understood, however, that the invention is not confined to the specific limitations set forth in the individual examples, but rather defined within the scope of the appended claims.

### EXAMPLE 1

An article of the present invention was prepared by laminating Apertured PENTAFLEX L 1.0 ml film, available through Tredegar Corporation, with 42 grams per square meter (“gsm”) spunbond polypropylene (“SBPP”) available through Atex Company. The lamination was performed under vacuum formed lamination (“VFL”).

### EXAMPLE 2

An article of the present invention was prepared by laminating Apertured 14 Square 1.0 ml film, available through Tredegar Corporation, with 42 gsm SBPP available through Atex Company. The lamination was performed under VFL.

### EXAMPLE 3

An article of the present invention was prepared by laminating Apertured 14 Square 1.0 ml film, available through Tredegar Corporation, with 32 gsm SBPP available through Atex Company. The lamination was performed under VFL.

### EXAMPLE 4

An article of the present invention was prepared by laminating Apertured PENTAFLEX L 1.0 ml film, available through Tredegar Corporation, with 27 gsm SBPP available through Atex Company. The lamination was performed under VFL.

### EXAMPLE 5

An article of the present invention was prepared by laminating Apertured Pentagonal 1.0 ml film, available through Tredegar Corporation, with 27 gsm SBPP available through Atex Company. The lamination was performed under VFL.

### EXAMPLE 6

An article of the present invention was prepared by laminating Apertured PENTAFLEX L 0.8 ml film, available through Tredegar Corporation, with 27 gsm SBPP available through Atex Company. The lamination was performed under VFL.

### EXAMPLE 7

An article of the present invention was prepared by laminating Apertured Pentagonal 0.8 ml film, available through Tredegar Corporation, with 27 gsm SBPP available through Atex Company. The lamination was performed under VFL.

### EXAMPLE 8

An article of the present invention was prepared by laminating Apertured 25 Pentagonal Soft Blend 0.8 ml film, available through Tredegar Corporation, with 27 gsm SBPP available through Atex Company. The lamination was performed under VFL.

### EXAMPLE 9

An article of the present invention was prepared by laminating Apertured 25 Pentagonal Soft Blend 0.8 ml film, available through Tredegar Corporation, with 24 gsm carded thermally bonded polypropylene available through Pantex Company. The lamination was performed under VFL.

### EXAMPLE 10

An article of the present invention was prepared by laminating Apertured 19 mesh PENTAFLEX L Soft Blend 0.8 ml film, available through Tredegar Corporation, with 22 gsm carded thermally bonded polypropylene available through Pantex Company. The compression of the film is 35.2 resilience is 98.0. (other suitable The density of the apertures in the film was approximately 55 per cm². The diameter of the apertures was 579 microns in the machine direction and 616 microns in the cross machine direction. The lamination was performed under VFL. The laminate had a thickness of 0.66 mm.

The samples above were tested for compressibility, resiliency, and drapability as described above. The results are reported in Table 1.

TABLE 1

| Sample | Drapability | Compressibility | Resiliency | Bond Strength |
|---|---|---|---|---|
| 1 | NA | 15.7 | 95.9 | 156 |
| 2 | NA | 23.8 | 95.3 | 161 |
| 3 | NA | 15.3 | 96.7 | 58.5* |
| 4 | NA | 16.9 | 92.8 | NA |
| 5 | NA | 14.0 | 93.5 | NA |
| 6 | NA | 18.4 | 94.2 | 136 |
| 7 | NA | 18.5 | 94.1 | 129 |
| 8 | 39.8 | 18.2 | 96.1 | 118 |
| 9 | 36.4 | 20.0 | 96.4 | 235 |
| 10 | 32.0 | 28.9 | 94.4 | 290 |

NA = not analyzed
* = cohesive failure

Based on the data above, the articles of the present invention provide personal care products with acceptable softness and flexibility.

We claim:

1. A bilayer laminated personal care article comprising:
an apertured film layer having a smooth side and a rough side; and
an absorbent layer, wherein the absorbent layer is laminated to the smooth side of the apertured film layer, and the article is useful for providing skin care benefits.

2. The article according to claim 1 wherein the article has a drapability of from about 25 mm to about 100 mm.

3. The article according to claim 2 wherein the article has a drapability of from about 25 mm to about 75 mm.

4. The article according to claim 3 wherein the article has a drapability of from about 25 mm to about 40 mm.

5. The article according to claim 1 wherein the article has a compressibility greater than about 14 percent.

6. The article according to claim 5 wherein the article has a compressibility greater than about 18 percent.

7. The article according to claim 6 wherein the article has a compressibility greater than about 25 percent.

8. The article according to claim 1 wherein the article has a resiliency greater than about 85 percent.

9. The article according to claim 8 wherein the article has a resiliency greater than about 90 percent.

10. The article according to claim 9 wherein the article has a resiliency greater than about 94 percent.

11. The article according to claim 1 wherein the article has a bond strength from about 70 g/cm² to about 350 g/cm².

12. The article according to claim 11 wherein the article has a bond strength from about 100 g/cm² to about 300 g/cm².

13. The article according to claim 12 wherein the article has a bond strength from about 150 g/cm² to about 300 g/cm².

14. The article according to claim 1 wherein the absorbent layer is a nonwoven and has a basis weight ranging from about 10 grams per square meter to about 200 grams per square meter.

15. The article according to claim 14 wherein the absorbent layer has a basis weight ranging from about 15 grams per square meter to about 100 grams per square meter.

16. The article according to claim 15 wherein the absorbent layer has a basis weight ranging from about 20 grams per square meter to about 50 grams per square meter.

17. The article according to claim 1 wherein the apertured film is made from a polymeric material selected from the group consisting of polyethylene, metallocene catalyzed polyethylene, polypropylene, and copolymers thereof, blends of various molecular weight polymers, and ethylene vinyl acetate copolymers.

18. The article according to claim 17 wherein the polymeric material is a blend of various molecular weight polyolefins.

19. The article according to claim 18 wherein the apertured film contains from about 1 apertures/cm² to about 300 apertures/cm² and the diameter of the apertures ranges from about 0.01 cm to about 0.6 cm.

20. The article according to claim 1 wherein the article has an apertured film thickness ranging from about 0.015 mm to about 0.038 mm.

21. The article according to claim 20 wherein the article has an apertured film thickness ranging from about 0.018 mm to about 0.030 mm.

22. The article according to claim 21 wherein the article has an apertured film thickness ranging from about 0.020 mm to about 0.025 mm.

23. The article according to claim 22 wherein the apertured film is made from a blend of various molecular weight polyolefins, the article has a drapability of from about 25 mm to about 40 mm, the absorbent layer is a nonwoven having a basis weight ranging from about 20 grams per square meter to about 50 grams per square meter, the article has a compressibility greater than about 25 percent, the article has a resiliency greater than about 94 percent, and the article has a bond strength from about 150 g/cm² to about 300 g/cm².

24. A method of massaging, cleansing, scrubbing, treating, and/or exfoliating the skin comprising:
using the personal care article of claim 1.
